(19) United States
(12) Patent Application Publication
(10) Pub. No.: US 2003/0187654 A1
(43) Pub. Date: Oct. 2, 2003

(54) Mobile audio player

(75) Inventor: Kiyoshi Hoshino, Ome-shi (JP)

Correspondence Address: FOLEY AND LARDNER, SUITE 500, 3000 K STREET NW, WASHINGTON, DC, 20007, US

(73) Assignee: KABUSHIKI KAISHA TOSHIBA

(21) Appl. No.: 10/396,820

(22) Filed: Mar. 26, 2003

(30) Foreign Application Priority Data
Mar. 29, 2002 (JP) 2001-097999

(51) Int. Cl. G10L 21/00

(52) U.S. Cl. 704/270; 704/273

(57) ABSTRACT

Music files are downloaded to a card type hard disk (4) having a large capacity, using a personal computer (2) in which a dedicated application program is installed. A battery operated hand-held mobile audio player (6), to which the hard disk card (4) is removably inserted, reproduces the music file to play music. The mobile audio player has a small size (such as hand-held), and is capable of being driven for a long time with a battery, and further, can secure a sufficient storage capacity.

### CROSS-REFERENCE TO RELATED APPLICATIONS

This application is based upon and claims the benefit of priority from the prior Japanese Patent Application No. 2002-097999, filed Mar. 29, 2002, the entire contents of which are incorporated herein by reference.

### BACKGROUND OF THE INVENTION

1. Field of the Invention

The present invention relates to a mobile audio player that is capable of being driven with a battery.

2. Description of the Related Art

There has been proposed a mobile audio player, which stores a music file such as MP3 on a hard disk of a small-size portable personal computer. However, the above audio player has a functional structure similar to that of a personal computer, and although it is portable, there is a limit in downsizing its structure. Therefore, the above-mentioned audio player has a problem in that it is difficult to drive it with a battery for a long time.

In order to solve this problem, the following audio player has been developed. That is, a music file is stored in a removable storage medium, e.g., a memory card such as COMPACT FLASH (registered trademark) and SMART MEDIA (registered trademark). In other words, the music file is not stored in the hard disk of the personal computer. The removable storage medium is removed from the personal computer, and thereafter, is mounted to a small-size dedicated player so that the music file can be played. However, the memory card has a limited storage capacity, and thus can merely store only several tens of songs.

As described above, in known mobile audio players one can not simultaneously satisfy the following requirements, that is, achieve miniaturization and secure a sufficient storage capacity.

### BRIEF SUMMARY OF THE INVENTION

The present invention is directed to an apparatus that substantially obviates one or more of the problems due to limitations and disadvantages found in the related art.

According to one aspect of the present invention, a mobile audio player includes a main body having a front surface, a rear surface, and a plurality of side surfaces, and a display on the front surface of the main body. The mobile audio player includes a card slot, and a removable hard disk card is removably inserted into the card slot, the hard disk card containing music files recorded from an external source. A player portion produces music by reproducing the music files contained on the hard disk card during a time when the hard disk card is inserted in the card slot, and a sound output terminal outputs the music.

According to an aspect of the present invention, the mobile audio player has a small size, and is capable of driving for a long time by a battery, and further, can secure a sufficient storage capacity.

### BRIEF DESCRIPTION OF THE DRAWINGS

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a perspective view showing the entire configuration of a system including a mobile audio player according to the first embodiment of the present invention;

FIG. 2 is a block diagram schematically showing read/write processing of a mobile disk in the first embodiment of the present invention;

FIG. 3 is a view showing a directory structure of music files stored in the mobile disk in the first embodiment of the present invention;

FIGS. 4A to 4E are views showing the mobile audio player according to the first embodiment of the present invention in which FIG. 4A shows a left side surface of the mobile audio player, FIG. 4B shows a front surface thereof, FIG. 4C shows a right side surface thereof, FIG. 4D shows a top surface thereof, and FIG. 4E shows a bottom surface thereof;

FIG. 5 is a block diagram showing a logic circuit of the mobile audio player according to the first embodiment of the present invention; and

FIG. 6 is a flowchart showing an operation of the mobile audio player according to the first embodiment of the present invention.

### DETAILED DESCRIPTION OF THE PREFERRED EMBODIMENTS OF THE INVENTION

An embodiment of a mobile audio player according to the present invention will now be described with reference to the accompanying drawings.

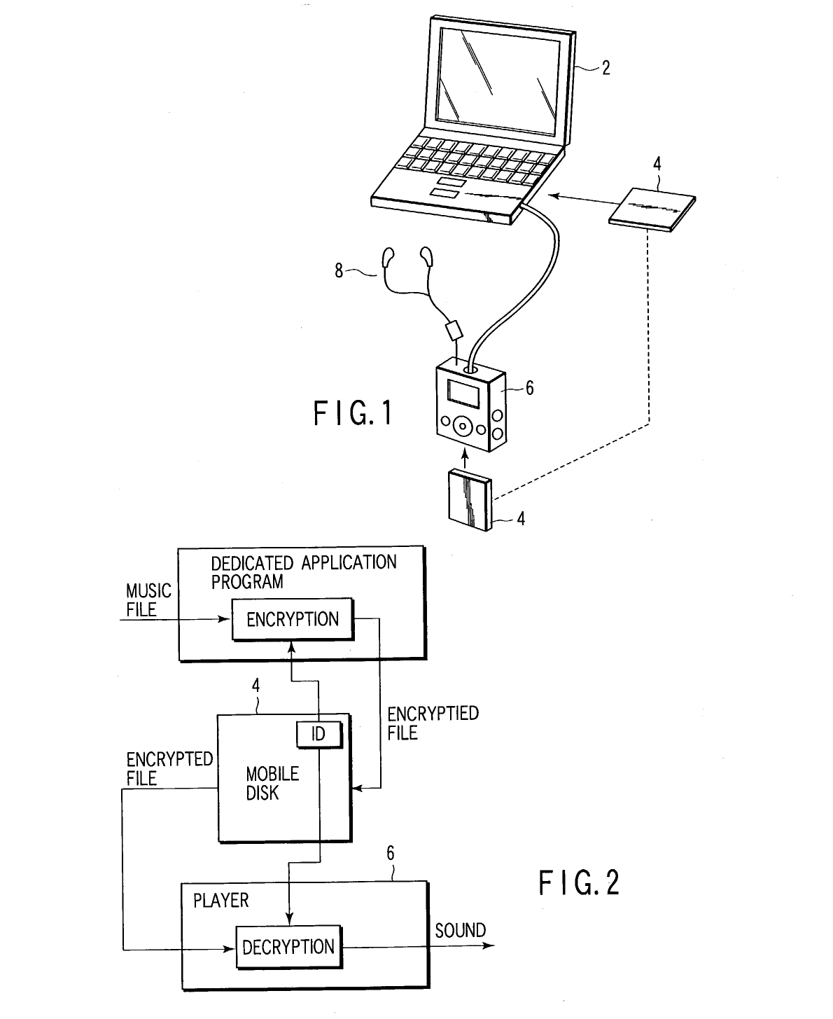

FIG. 1 is a perspective view to explain the entire configuration of a system including a mobile audio player according to the first embodiment of the present invention. The present system is a mobile audio player system with a mobile disk 4, which has a large capacity and excellent portability as a storage medium. The mobile disk 4 is configured in a manner that a 1.8-inch hard disk drive is built in a PC card (e.g., PCMCIA Type II). In the embodiment, the corresponding audio formats are MP3, MP3(VBR), WMA, WAV and non-compressed PCM, which have currently come into wide use in personal computers, the Internet and the like. In the embodiment, the mobile disk 4 has a capacity of 2 GB or 5 GB, and can store 1000 music files in a 5-GB disk if the file is compressed based on MP3/WMA. Further details on an exemplary construction of the mobile disk can be found in U.S. application Ser. No. 10/233,403, filed on Sep. 4, 2002, entitled “CONNECTOR UNIT, ELECTRONIC APPARATUS SYSTEM PROVIDED WITH THE SAME, ELECTRONIC APPARATUS PROVIDED WITH CONNECTOR, AND MAIN APPARATUS PROVIDED WITH CONNECTOR,” assigned to the same assignee as the present application, and this application is incorporated herein in its entirety.

In order to write the music file to the mobile disk 4, a dedicated application program is installed on a personal computer 2, and then, the music file stored on a hard disk of the personal computer 2 is downloaded to the mobile disk 4. In order to store the music file in the personal computer 2, the following methods are employed. One method includes playing a music CD inserted in a CD-ROM drive, and compressing the music data. Another method includes downloading a music file from the Internet.

In order to download the music file to the mobile disk 4 from the personal computer 2, either of the following methods may be employed. One method includes inserting the mobile disk 4 into a PC card slot of the personal computer 2. Another method includes making a USB connection between the personal computer 2 and a mobile audio player 6 (which may be a dedicated player in some embodiments) in a state such that the mobile disk 4 is inserted into a PC card slot of the player 6. In the case of the USB connection, a high-speed transfer (6 MB/sec.) such as USB 2.0 may be used.

As shown in FIG. 2, in a dedicated application program 2A (residing in the personal computer 2), when the music file is downloaded to the mobile disk 4 from the personal computer 2, the music file is encrypted by using identification (ID) information 4A specific to the disk 4 and stored in the disk 4 as an encryption key. This inhibits a grandchild copy of the file in the mobile disk 4 from being created. That is, a copy of the file from the mobile disk with the ID cannot be made. Numerous copies of the music file can be downloaded from the computer to different mobile disks 4, each of which will have unique identification information. Further, the dedicated application program 2A inhibits the file from being reproduced from the mobile disk 4 and the player 6 inhibits the reproduced (decoded and decrypted) music data from being output to the outside in a playable manner. In the embodiment, music cannot be recorded from one mobile player to another as plain state data, meaning decoded and decrypted. Since the ID 4A stored in the disk 4 is used as the encryption key, it is possible to playback (reproduce) the data even if the mobile disk 4 is inserted into any player 6. As an alternative, the ID 4A could be made specific to the player 6, so that the given hard disk could only be used with the specific player. Further, the dedicated application program 2A determines whether or not an object media is the mobile disk 4, and carries out music file screening and play list creation. The play list is downloaded as a file to the mobile disk 4 just like the music file.

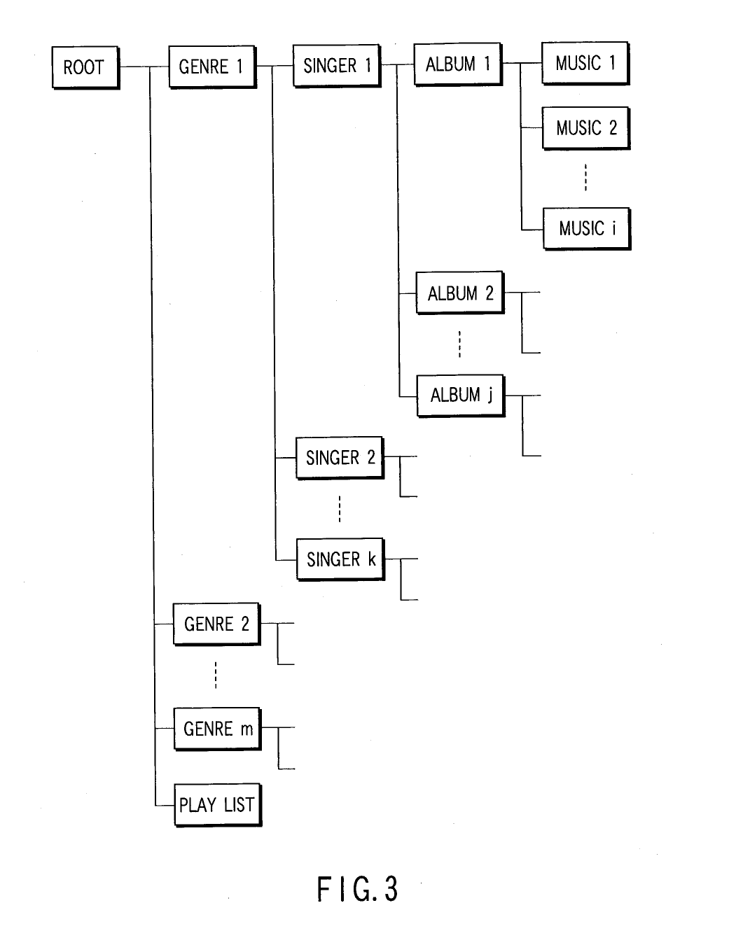

The mobile audio player 6 includes a 1.8-inch display device, which displays an internal directory structure of the mobile disk 4. FIG. 3 shows one example of a directory display. Using the directory display, it is possible to select a desired file, album or singer to be played from the music files such as the 1000 song files. Also, a play list file 3A is included in the directory structure like the music files. The directory structure is built up by the dedicated application program 2A when the music file is downloaded to the mobile disk 4 from the personal computer 2. The player 6 can retrieve (search) the music file based on, for example, a keyword.

The mobile disk 4 is also usable as a normal external storage device; therefore, the mobile disk 4 can store a data file (e.g., document file prepared by word processor, image file, other application program files such as mail, games and schedule management) of another application program in addition to the music file. However, in the directory display of the player 6, only audio file and play list file 3A transferred by the dedicated application program 2A are displayed, and other files are not displayed therein.

The files displayed in the directory structure are arranged in file name sequence or date sequence. A predetermined folder name or file name is automatically given by the dedicated application program 2A when downloading the music file. Therefore, if a user can add a serial number to a header of the predetermined folder name or file name, music files can be played in the title sequence. If music files are downloaded from a CD and a file name is automatically extracted from the CD, music can not be played in the title sequence. However, if the music files are downloaded in the title sequence and then are played in the date sequence, the music files are playable in the title sequence.

The player 6 has a several MB, e.g., 8 MB buffer in order to achieve the purpose for preventing missing sound and reducing the drive power consumption of the mobile disk 4. That is, the mobile disk 4 is not always powered on, but is powered off once after the data has been transferred to the buffer, and thereafter, reproduces the data stored in the buffer. Then, the mobile disk 4 repeats the following operation such that the power is again turned on before the data to be reproduced is fully out of stock, and sequentially, the next data is transferred to the buffer. Thus, the player 6 enables 10 hours or more of continuous playback by the above low power consumption drive technology and by including a lithium ion battery having a large capacity. It is preferable that a battery of 3.7 V, 2000 mAh be used as the lithium ion battery. The player 6 can also be driven by an external power supply (e.g., AC adapter of 5V, 3A), and the lithium ion battery is charged by connecting the player 6 to an external power supply.

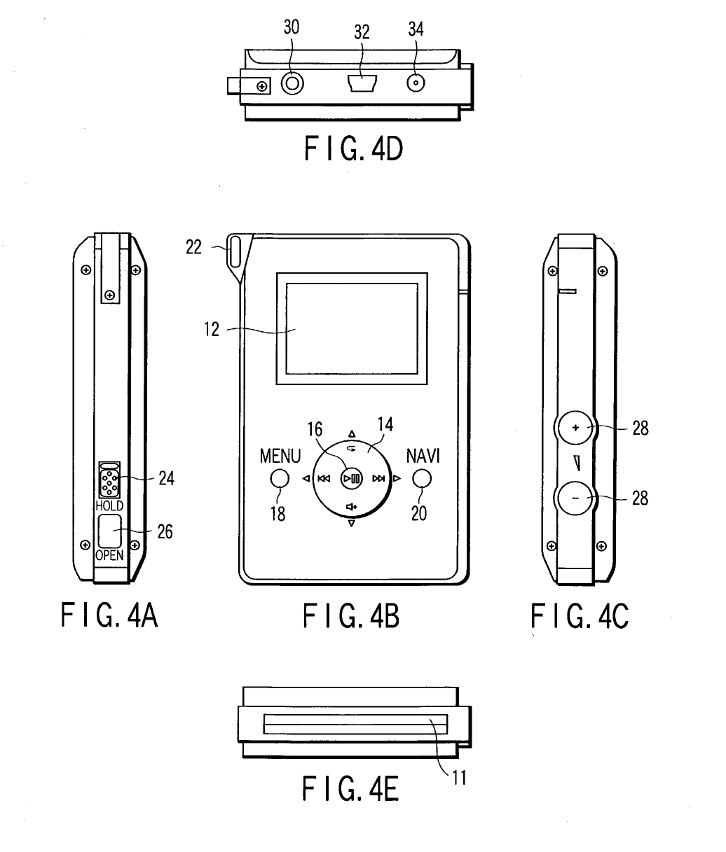

FIG. 4A to FIG. 4E are views showing a configuration of the mobile audio player 6 according to the first embodiment. FIG. 4A shows a left side surface of the audio player 6, FIG. 4B shows a front surface thereof, FIG. 4C shows a right side surface thereof, FIG. 4D shows a top surface thereof and FIG. 4E shows a bottom surface thereof.

As shown in FIG. 4E, the bottom surface of the mobile audio player 6 is provided with an insertion gate of a slot to which a mobile disk is inserted, and the insertion gate is provided with a cover 11. The cover 11 is provided with a sensor for detecting an open/close state, and when the cover 11 is opened during music playback, the playback is immediately stopped. A well-known sensor may be used as the open/close sensor. For example, the sensor may have a configuration such that an inner side of the cover 11 is formed with a projected portion, and a pressure sensor is provided at the position corresponding to the projected portion in a case (housing). Further, a sensor with the following configuration may be used. That is, a light emitting/receiving element is provided in the case and a reflecting plate is provided at the position corresponding to the inner side of the cover 11 so that a light emitted from the light emitting element can be reflected by the reflecting plate of the closed cover 11, and can be incident on the light receiving element. Although not shown, the mobile disk runs from power supplied by the mobile audio player, thought it is contemplated that the battery can be built into the rear side of the mobile disk 4.

As shown in FIG. 4B, the upper portion of the front surface of the player 6 is provided with a 1.8-inch monochrome liquid crystal (STN liquid crystal) display device 12. The display device 12 has a display screen of 160×120 dots, and a blue LED backlight (three LEDs). The lower portion of the front surface is provided with a circular-shaped four-position key 14 and an enter key 16 at the center of the four-position key 14. Both sides of the four-position key 14 are provided with a MENU key 18 functioning as a mode changeover key and a NAVI (navigation) key 20. The four-position key 14 has four keys, that is, LEFT, RIGHT, UP and DOWN keys in left and right, up and down positions. As will be described later, each key function provides a different operation mode. The left upper portion of the front surface of the mobile audio player 6 is formed with a strap holder 22.

As shown in FIG. 4A, the lower portion of the left side surface of the player 6 is provided with a HOLD switch 24 and an OPEN switch 26. The HOLD switch 24 locks each key while locking the slot cover 11 of the bottom surface. The OPEN switch 26 is a switch for opening the cover 11. When the HOLD switch 24 is turned on, the OPEN switch 26 is also made inoperative.

As shown in FIG. 4C, the right surface of the player 6 is provided with plus “+” and minus “−” volume keys 28.

As shown in FIG. 4D, the top surface of the player 6 is provided with a headphone terminal 30, a USB terminal (USB2.0) 32 and a power supply terminal 34 to be connected with an AC adaptor. The headphone terminal 30 is connected with stereo mini headphones (attached with remote controller) 8 as shown in FIG. 1. The remote controller has six keys, that is, NEXT, PREV, EQ, PLAY/PAUSE, VOL+ and VOL− keys.

The following Table 1 shows various key functions in each operation mode. The player 6 has a play mode as the operation mode in addition to a menu mode and a navigation mode. The play mode is a mode for playing a music file; on the other hand, the navigation mode is a mode for selecting a music file to be played, and displaying a directory structure of the music file. The menu mode is a mode for carrying out various setups such as sound quality (equalizer) setup, “yes” or “no” of repeat playback, and displaying language selection.

TABLE I

| | |
|---|---|
| Key | Operation mode |

| Main | Remote | | | Navigation |
|---|---|---|---|---|
| body | controller | Play mode | Menu mode | mode |
| RIGHT | NEXT | Next Track/FF | Move cursor | Move |
| | | | to right | cursor to |
| | | | | right |
| LEFT | PREV | Prey Track/REW | Move cursor | Move |
| | | | to left | cursor to |
| | | | | left |
| UP | | Play mode setup | Move cursor | Move |
| | | | up | cursor up |
| DOWN | EQ | Sound quality | Move cursor | Move |
| | | (EQ) setup | down | cursor |
| | | | | down |
| ENTER | PLAY/ | Play/Pause | confirmation | Select |
| | PAUSE | | | music to |
| | | | | be played |
| | | | | Transfer to |
| | | | | play mode |
| NAVI | | Transfer to | Transfer to | Transfer to |
| | | navigation mode | navigation | play mode |
| | | | | mode |
| MENU | | Transfer to menu | Transfer to | Transfer to |
| | | mode | play mode | menu |
| | | | | mode |
| VOL+ | VOL+ | Volume increase | Same as left | Same as |
| | | | | left |
| VOL− | VOL− | Volume decrease | Same as left | Same as |
| | | | | left |

In the navigation mode, moving the cursor right and left selects a directory. More specifically, moving the cursor to the left moves the cursor to a one-level higher hierarchical directory; on the other hand, moving the cursor to the right moves the cursor to a one-level lower hierarchical directory. Moreover, according to the cursor movement to up and down, the cursor is movable in a directory for selecting folder and file.

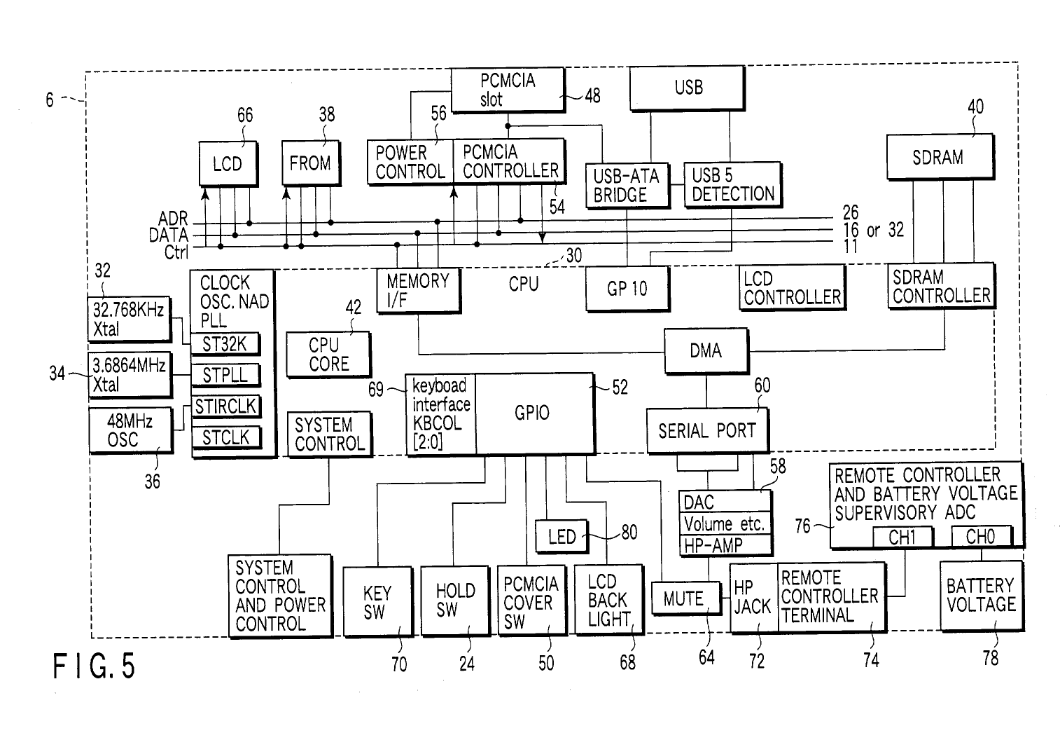

FIG. 5 is a block diagram showing a circuit configuration of the mobile audio player 6.

A CPU 100 carries out audio data decoding, file system management, user interface control and the like. The CPU 100 is mounted with a 32.768 kHz crystal resonator 33, a 3.6864 MHz crystal resonator 35, and a 48 MHz oscillator 36 as a clock of the CPU 100. The 48 MHz oscillator 36 oscillates when the CPU 100 is in a run mode or in an idle mode. A firmware is stored in a NOR-type flash memory (FROM) 38. Programs are executed on an SDRAM 40. The SDRAM 40 is also used as an audio data buffer. In order to reduce power consumption during standby, it is preferable that a low power consumption component having a lower self-refresh current be used as the SDRAM 40.

One PCMCIA Type II slot 48 is mounted as an interface I/F with the mobile disk 4.

As described above, a card insertion section (slot) is provided with the cover 11, and a detection signal from a switch 50 for detecting an opening and closing state is connected to a GPIO 52 of the CPU 100. The GPIO 52 is set by interruption.

An operating voltage of the mobile disk 4 is only 3.3 V. The CPU 100 can carry out an on/off control for power to the mobile disk 4. CPU 100 operates only the mobile disk. However, even if another PC card is connected to the player 6, the player 6 and the card are not damaged.

The current capacity of an internal power switch of PCMCIA controller 54 is insufficient to drive the mobile disk 4. Therefore, a power control circuit 56 with respect to the mobile disk 4 is provided external to the controller 54. The power control is made by a resistor setting in the controller 54.

The mobile audio player 6 includes a headphone amplifier 58 with an equalizer (EQ) function for sound qualities BASS and TREBLE and a volume control function and an D/A converter. The equalizer has only boost, and has no minus equalization.

An audio digital data outputted from the CPU 100 is inputted to the D/A converter 58. A serial port 60 of the CPU 100 is connected to a digital data input pin of the D/A converter 58.

In order to prevent a pop noise generated in the power on/off operation, a mute circuit 64 is provided external to the D/A converter 58. An LCD controller built in the CPU 100 is not used to control the liquid crystal display device 12. The liquid crystal display device 12 has a RAM built-in LCD driver 66, which is connected to a data bus of the CPU 100. A blue LED backlight (three LEDs) 68 is connected to the GPIO 52 of the CPU 100 as a backlight. The HOLD switch 24 is connected to the GPIO 52 of the CPU 100. Push switches such as four-position key 14, enter key 16, mode changeover keys 18 and 20 are connected to a key switch matrix 70. A column signal is connected to a keyboard interface KBCOL 69 on the other hand, a row signal is connected to a PC [7:0] of the GPIO 52. A headphone jack 72 is a four-pin type, and one pin is used as a remote control terminal 74. A remote control signal from the remote controller is connected to a remote controller and battery voltage controller ADC 76. A power (pull-up power) used for the remote controller is on/off-controlled by the CPU 100. In order to reduce current consumption, the pull-up power is turned off in the off-operation (when the CPU 100 is in a standby mode). A voltage detector IC 78 detects a voltage drop of the battery, and informs the CPU 100 of the detection result using interruption. Charge control of the battery is carried out using a charge IC. The on/off of charging operation is controlled by hardware. The charge operation is started when an AC adaptor is connected to the power supply terminal 34. An LED 80 shows a charge state. The LED 80 uses two-colors LED, that is, red/green LED. Further, the LED 80 is controlled by the charge IC, and not by the CPU 100.

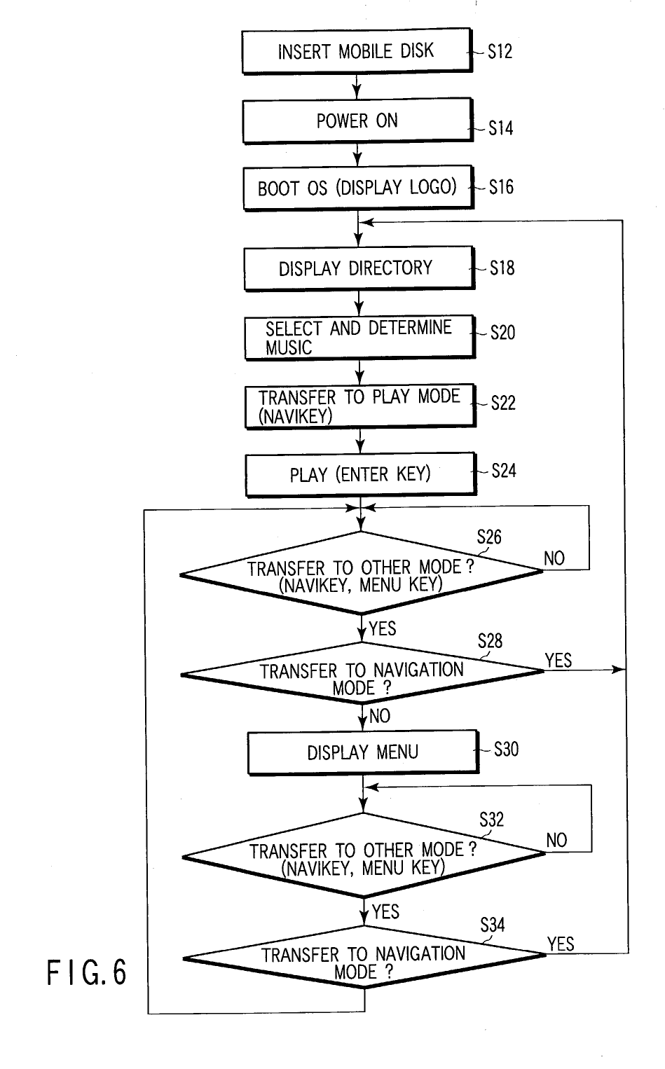

FIG. 6 is a flowchart schematically showing an operation of the mobile audio player according to the first embodiment.

In step S2, the mobile disk 4 is inserted into the card slot of the player 6. When the player 6 is powered on in step S14, the operating system starts up in step S16. The player's logo is displayed during the start-up. The navigation mode is started, and then, the directory structure is displayed in step S18. In step S20, the user selects the music to be played. If a play list is displayed, the user only selects the file name in the play list, and thereby, the music to be played is determined. The selection is not limited to music unit, and it may include the selection of any folder such as genre, singer, album and the like. When the folder is selected, it means that all music in the lower level folders than the selected folder can be selected. Thereafter, when the NAVI key 20 is depressed, in step S22, the operation mode is transferred to the play mode. In the play mode, when the enter key 16 is depressed, music play is started in step S24. If the repeat play is selected in the play mode, the play of the selected music is completed, and thereafter, the same music is again played.

During the play mode, when either of the NAVI key 20 or the MENU key 18 is depressed (yes in step S26), it is determined in step S28 whether or not the operation mode is transferred to the navigation mode. If the operation mode is transferred to the navigation mode, the control sequence returns to step S18, and then, it is possible to again select the music to be played. Of course, in this case, the play continues. On the other hand, if the operation mode is transferred to the menu mode, the menu is displayed in step S30, and various setups are possible.

During the menu mode, when either of the NAVI key 20 or the MENU key 18 is depressed (yes in step S32), it is determined in step S28 whether or not the operation mode is transferred to the navigation mode. If the operation mode is transferred to the navigation mode, the control sequence returns to step S18, and then, it is possible to again select music to be played. Of course, in this case, the play continues. On the other hand, if the operation mode is transferred to the play mode (no in step S34), the control sequence returns to step S26. Although not illustrated in the flowchart of FIG. 6, a skip (forward direction, backward direction) of the playing track is carried out when right and left keys of the four-position key 14, that is, RIGHT and LEFT keys are depressed during the playing operation.

As described above, according to the first embodiment, the music file is downloaded to the card type hard disk 4 (good portability) using a personal computer 2 in which the dedicated application program 2A is installed, and then, the dedicated player 6 mounted with the hard disk 4 plays the music file thus downloaded. Thus, it is possible to provide a mobile audio player, which has a small size, and is capable of using (playing) for a long time by a battery, and further, can secure a sufficient storage capacity. As an example, the mobile audio player weighs about 500 g or less, such as about 200 g. As an example, the mobile audio player runs for at least 10 hours on a charged battery. As an example, the mobile audio player has a width ranging between 60 and 90 mm, a height ranging between 15 and 40 mm, and a depth ranging between 90 and 150 mm. As an example, the mobile audio player has dimensions of about 70 mm×20 mm×110 mm. The hard disk card has a width ranging between 40 and 65 mm, a height ranging between 2 and 10 mm, and a depth ranging between 75 and 90 mm. As an example, the hard disk card has dimensions of about 55 mm×5 mm×85 mm. When the music file is downloaded, the music file is encrypted by using specific identification information 4A stored in the hard disk 4 as an encryption key. Therefore, it is possible to prevent a grandchild copy of the music file in the hard disk from being stored to another hard disk. The player 6 has the display device 12, which displays a directory structure of the disk 4; therefore, it is possible to readily select a file to be played from a large number of music files. A buffer memory is used to play the music file, and thereby, there is no need of always turning on the power of the hard disk 4; therefore, power consumption can be further reduced.

Further, the card slot is capable of removably mounting a card type hard disk, which is mounted into a card slot of a personal computer and is capable of recording a music file on the personal computer, from the side surface of the main body.

The card type hard disk is used as a freely removable storage medium; therefore, a large number of music files can be stored. Moreover, the dedicated player is mounted with the hard disk to play the music file, and thereby, the player is capable of being driven by a battery for a long time even if it has a small size.

While the description above refers to a particular embodiment of the present invention, it will be understood that many modifications may be made without departing from the sprit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

For example, the player of the present invention has a PCMCIA type card slot. Not only the hard disk card, but also other PC cards may be inserted into the slot. In place of the hard disk, a wireless LAN card may be inserted in the slot so that the mobile audio player of the present invention can be connected with a network via the inserted wireless LAN card. By doing so, a music file stored in a specified storage on the network is transferred to the present player by a streaming via a wireless (radio) base station, and thereafter, the player may play the music file.

Further, the player of the present invention has a small size and is capable of being driven by a battery for a long time; therefore, instead of the music file, an application program can be stored in the hard disk, and then, the stored application program may be executed. As an example of the application program, a game, schedule management, electronic mail program and the like could be used. In order to execute the application program, Qt/MICROWINDOWS (registered trademark), which is a standard graphics IF in LINUX (registered trademark) may be installed.

Further, the player is equipped with an NTSC input I/F connectable with video cameras and an MPEG4 codec, and thereby, it is possible to realize a video terminal capable for readily performing video imaging. Further, the downloading and playing of video data using a hard disk card is contemplated.

What is claimed is:

1. A mobile audio player comprising:
a hand-held main body having a front surface, a rear surface, and a plurality of side surfaces;
a display on the front surface of the main body;
a card slot;
a removable hard disk card removably inserted into the card slot, the hard disk card containing music files recorded on the hard disk card from an external source;
a player portion that produces music by reproducing the music files contained on the hard disk card during a time when the hard disk card is inserted in the card slot;
a sound output terminal for outputting the music.

2. The mobile audio player of claim 1, wherein the external source is a personal computer.

3. The mobile audio player of claim 2, wherein the main body has a top side surface, a bottom side surface, a right side surface, and a left side surface, and
wherein the card slot has an insertion gate located on the bottom side surface.

4. The mobile audio player of claim 3, further comprising a cover covering the insertion gate, the cover being positionable in a gate open state or a gate closed state.

5. The mobile audio player of claim 4, wherein the cover comprises a detector that detects the state of the cover, and when the cover is in the gate open state, the player stops reproducing the music files.

6. The mobile audio player of claim 4, further comprising a lock for locking the cover.

7. The mobile audio player according to claim 3, further comprising a volume control member provided at one of the right side surface and the left side surface and a control member provided on the front surface of the main body, and
wherein the sound output terminal is positioned on the top side surface.

8. The mobile audio player according to claim 1, wherein the display displays a directory of the music files.

9. The mobile audio player according to claim 8, wherein the display displays the music files in the directory according to at least one of date and name of the music files.

10. The mobile audio player according to claim 8, wherein the player portion is capable of selecting a desired group of music files in the directory, and repeatedly reproducing the selected group of music files.

11. The mobile audio player according to claim 1, wherein the player portion comprises
an operation instruction button provided on the front surface of the main body,
an operation mode designation button provided on the front surface of the main body, and
means, provided on the front surface of the main body, for changing a function of the operation instruction button in accordance with an operation mode designated by the operation mode designation button.

12. The mobile audio player according to claim 11, wherein the operation instruction button comprises a four-position key having four switches in up, down, right and left positions.

13. The mobile audio player according to claim 1, further comprising a wireless LAN card that can be removably inserted in the slot, and the player portion is capable of reproducing another music file transmitted from a wireless LAN base station via the wireless LAN card.

14. The mobile audio player according to claim 1, wherein the external source is a personal computer, and the mobile audio player further comprises:
a signal input terminal, for connection to a personal computer via a signal line, the signal input terminal inputs music files from the personal computer; and
a recorder portion that records the inputted music files to the hard disk card that is inserted in the slot.

15. The mobile audio player according to claim 1, wherein the hard disk card stores an application program, the mobile audio player further comprises means for executing the application program, and wherein the display displays data relative to the executed application program.

16. The mobile audio player according to claim 15, wherein the application program is at least one of a game program, a schedule management program, and an electronic mail program.

17. The mobile audio player according to claim 1, wherein the player portion comprises a buffer storing at least one selected music file from the hard disk card, and
wherein the player portion produces music by reproducing the at least one selected music file directly from the buffer.

18. The mobile audio player according to claim 17, wherein the hard disk card is powered down for at least a portion of the time that the player portion is reproducing the at least one selected music file directly from the buffer.

19. The mobile audio player according to claim 17, wherein the hard disk card is powered down for at least a portion of the time that the player portion is reproducing the at least one selected music file directly from the buffer.

20. The mobile audio player according to claim 17, wherein the player portion produces music only by reproducing music files directly from the buffer.

21. The mobile audio player according to claim 17, wherein the buffer is a synchronous dynamic random access memory.

22. The mobile audio player according to claim 17, wherein the player portion cannot reproduce music files from the buffer if the hard disk card is removed from the slot.

23. The mobile audio player according to claim 1, wherein the external source is a personal computer, and wherein the music files are recorded on the hard disk card when the hard disk card is inserted in the personal computer.

24. The mobile audio player according to claim 1, wherein the external source is a personal computer, and wherein at least one of the music files recorded in the hard disk card is encrypted by the personal computer using identification information specific to the hard disk card, and the player portion decrypts the encrypted music file using the identification information.

25. The mobile audio player according to claim 24, wherein all the music files recorded on the hard disk are encrypted by the personal computer using identification information specific to the hard disk card.

26. The mobile audio player according to claim 24, wherein the identification information cannot be recorded from the hard disk card to another mobile audio player.

27. The mobile audio player according to claim 24, wherein the hard disk card is encrypted to be permitted to be used only with a single mobile audio player.

28. The mobile audio player according to claim 1, further comprising a video data input port that receives video data.

29. A mobile audio player comprising:
a hand-held main body having a front surface, a rear surface, and a plurality of side surfaces;
means for displaying information on the front surface of the main body;
a slot means for providing a space for insertion of a card;
a removable hard disk card removably inserted into the slot means, the hard disk card containing music files recorded on the hard disk card from an external source;
means for producing music by reproducing the music files contained on the hard disk card during a time when the hard disk card is inserted in the slot means; and
means for outputting the music.

30. A method for playing music using a hand-held mobile audio player having a removable hard disk card, comprising the steps of:
recording music files from an external source onto the removable hard disk card;
removing the removable hard disk card, having the recorded music files, from the external source;
inserting the removable hard disk card, having the recorded music files, in a card slot of the hand-held mobile audio player; and
playing music using the mobile audio player by reproducing the music files recorded on the removable hard disk card.

31. The method for playing music using a mobile audio player having a removable hard disk card of claim 30, wherein the external source is a personal computer, and wherein the step of recording music files is carried out using a dedicated application program stored on the personal computer.

32. The method for playing music using a mobile audio player having a removable hard disk card of claim 30, wherein the step of recording music files comprises encrypting the music files using identification information specific to the removable hard disk card.

33. A method for playing music using a hand-held mobile audio player having a removable hard disk card, comprising the steps of:
inserting the removable hard disk card in a card slot of the mobile audio player;
recording music files from an external source onto the removable hard disk card that has been inserted into the hand-held mobile audio player; and
playing music using the mobile audio player by reproducing the music files recorded on the removable hard disk card.

34. The method for playing music using a mobile audio player having a removable hard disk card of claim 33, wherein the external source is a personal computer, and wherein the step of recording music files is carried out using a dedicated application program stored on the personal computer.

35. The method for playing music using a mobile audio player having a removable hard disk card of claim 33, wherein the step of recording music files comprises encrypting the music files using identification information specific to the removable hard disk card.

36. The method for playing music using a mobile audio player having a removable hard disk card of claim 33, wherein the step of recording music files is carried out using a USB connection between the personal computer and the mobile audio player.
